(19) United States
(12) Patent Application Publication
(10) Pub. No.: US 2022/0039589 A1
(43) Pub. Date: Feb. 10, 2022

(54) ARRANGEMENT COMPRISING A COFFEE MACHINE AND A COFFEE GRINDER

(71) Applicant: RANCILIO GROUP S.P.A., Parabiago (MI) (IT)

(72) Inventors: Stefano RAIMONDI, Parabiago (MI) (IT); Valerio LOCATI, Parabiago (MI) (IT)

(21) Appl. No.: 17/281,428

(22) PCT Filed: Oct. 9, 2020
(86) PCT No.: PCT/IB2020/059498

§ 371 Date: Mar. 30, 2021

(30) Foreign Application Priority Data
Oct. 11, 2019 (IT) 102019000018605

(51) Int. Cl. A47J 31/52; A47J 31/42; A47J 31/00; A47J 31/44; A23F 5/26; A47J 42/40

(52) U.S. Cl. CPC A47J 31/525; A47J 31/42; A47J 42/40; A47J 31/446; A23F 5/26; A47J 31/007

(57) ABSTRACT

The invention relates to an arrangement comprising a coffee machine (100) and a coffee grinder (200), wherein said coffee machine is able to prepare a plurality of different coffee-based drinks according to several recipes. In order to avoid errors when preparing a specific recipe, the coffee machine (100) comprises a plurality of brewing groups and a corresponding plurality of filter holder assemblies (1), and at least one filter holder assembly (1)—preferably each filter holder assembly (1)—comprises an electronics (11) equipped with a memory (15), in which the parameters of one or more of said recipes are stored, and with communication devices (13) that allow said filter holder group to communicate on one hand with the electronics (101) of the coffee machine (100) and, on the other hand, to communicate with the electronics (201) of the coffee grinder (200), whereby said filter holder assembly communicates to each device the data necessary for preparing the selected recipe.

### TECHNICAL FIELD

The present invention relates to an arrangement comprising a coffee machine and a coffee grinder. More particularly, the present invention relates to an arrangement comprising a coffee grinder and an espresso coffee machine of the so-called “semi-automatic” type, i.e. of the type comprising one or more brewing groups and, for each brewing group, a filter holder adapted to contain a predetermined dose of coffee powder.

### BACKGROUND ART

Espresso coffee machines are known that comprise at least one brewing group for the coffee-based drink and, for each brewing group, a removable filter holder adapted to contain a desired dose of coffee powder, and a plurality of buttons for selecting the drink to be brewed by the corresponding brewing group.

It is also known to associated one or more coffee grinders to the coffee machine, each coffee grinder including a hopper arranged to contain the coffee beans to be ground, a dosing device and a grinding chamber for obtaining coffee powder from the coffee beans, the coffee powder being then discharged from the grinding chamber into a filter holder of the coffee machine.

Quantity and particle size of the coffee powder can be adjusted by adjusting the grinding time and the configuration of the grinding chamber (in particular, the distance between the grinder blades).

The possibility of adjusting the quantity and particle size of the coffee powder obtained in the coffee grinder is important because the coffee machine is usually configured so as to allow preparing different coffee-based drinks (different recipes), which may require different quantities of coffee powder and/or coffee powder with a specific particle size.

It is also possible that the same recipe can be prepared starting from differently roasted coffee beans or from decaffeinated coffee, or also by using single or double doses.

The same filter holder of the coffee machine can therefore be filled with coffee powder with different quantities and characteristics according to the consumer's order.

In the case where the quantity and/or the characteristics of the coffee powder dispensed by the coffee grinder differ from those required by the selected recipe, the resulting drink will have characteristics different from the desired ones, this causing consumers' dissatisfaction.

Since the coffee machines of the type described above are usually employed in commercial establishments, such as bars and restaurants, the consumers' (i.e. the clients') dissatisfaction and the resulting need to re-prepare the coffee-based drink, will result in time losses, economical losses and a negative image return.

In order to obviate this drawback, the document EP 2 314 188 aims at providing an arrangement allowing filling of a filter holder of a coffee machine in an accurate and reliable manner, in terms of both the quantity (dose) of coffee powder necessary for a selected recipe and the characteristics required for said coffee powder to prepare said recipe.

For this purpose, the document EP 2 314 188 describes an arrangement comprising a coffee machine and a coffee grinder, wherein:
the coffee machine comprises a plurality of brewing groups, each brewing group having a respective filter holder and a plurality of buttons corresponding to the different coffee-based drinks that can be selected and prepared by the coffee machine;
the coffee machine further comprises an electronic board equipped with short-range communication and radio communication devices;
each filter holder bears a code (for example, a barcode) that can be recognized by the electronic board of the coffee machine;
the coffee grinder comprises a grinding chamber for grinding the coffee beans and obtaining coffee powder to be dispensed to a filter holder;
the coffee grinder further comprises an electronic board capable of recognizing the code of each filter holder and equipped with short-range communication and radio communication devices compatible with the short-range communication and radio communication devices of the electronic board of the coffee machine.

Said arrangement may also comprise several coffee machines and several coffee grinders, for example with different starting coffee beans and different grinding settings.

In such arrangement, the operator using a brewing group of the coffee machine selects a certain recipe for a coffee-based drink, and the characteristics required for preparing said coffee-based drink are transmitted from the coffee machine to the coffee grinder.

When the filter holder of the aforesaid brewing group is placed onto the support located under the grinding chamber of the coffee grinder, the filter holder is recognized by the coffee grinder, which therefore dispenses the desired dose of coffee powder with the desired characteristics.

When the filter holder is brought back to its brewing group, the filter holder is recognized by the coffee machine, which therefore “knows” that the coffee powder contained in said filter holder has the correct quantity and quality and can thus start brewing the drink.

In the arrangement described in EP 2 314 188, errors in preparing the coffee powder necessary for a selected recipe are avoided thanks to the fact that the coffee grinder recognizes the code of the filter holder and dispenses the coffee powder only if the filter holder corresponds with the brewing group corresponding to the request received from the coffee machine, and to the fact that also the coffee machine recognizes the code of the filter holder and starts brewing the coffee powder only if the filter holder is positioned in the respective brewing group and not in another brewing group for which a different recipe might have been selected.

Although the arrangement described above may in fact prove useful to avoid errors in the preparation of the various coffee-based recipes, it has limitations.

In particular, in said arrangement each filter holder is uniquely related to a respective brewing group and cannot function except when applied to said brewing group.

This can lead to time losses if, for example, in very chaotic situations with several operators working on the coffee machine at the same time, one operator forgets from which brewing group he/she picked up the filter holder.

In addition, if a filter holder breaks, the corresponding brewing group automatically becomes unusable, and vice versa.

The document US 2003/0129286 describes an arrangement and a method for storing and communicating information relating to the preparation of a drink, such as the recipe of the drink itself. The arrangement described in US 2003/0129286 comprises a machine for preparing drinks, such as, for example, a coffee machine, a device for dispensing the raw material for the drink, such as, for example, a coffee grinder, and one or more funnels that can be coupled to the coffee grinder in order to be loaded with said raw material (i.e., coffee powder) and subsequently coupled to said coffee machine for proceeding to the preparation of the coffee-based drink.

The arrangement can prepare different coffee-based drinks, each with its own recipe. The funnel (or each funnel) is equipped with a memory unit and the coffee grinder and the coffee machine are equipped with respective communication means for reading said memory, as well as with respective control units for controlling the respective operations required for preparing the correct coffee-based drink based on the data read from the memory unit of the funnel.

In the described arrangement, the memory unit associated with the funnel contains the minimum basic information relating to the type and quantity of the drink selected by the user. The communication means of the coffee grinder read said basic information from the memory unit and, based on the type and quantity of the drink selected by the user, the control unit of the coffee grinder draws the corresponding recipe from its memory and controls the parameters of the grinder (grinding time, distance between the grinding parts, etc.) in order for the correct quantity of coffee powder with the required characteristics to be dispensed. When the funnel is subsequently associated with the coffee machine, the communication means of the coffee machine read the basic information about the drink to be brewed from the memory unit of the funnel and, based on the type and quantity of the drink selected by the user, the control unit of the coffee machine draws the corresponding recipe from its memory and controls the parameters of the coffee machine (water temperature and pressure, brewing time, etc.) in order for the correct drink to be brewed.

In the described arrangement, although some information is stored in the memory of the funnel, the coffee grinder and the coffee machine contain each the part of recipe of the drink to be prepared containing the instructions concerning the operations to be carried out by them. For example, the memory of the control unit of the coffee grinder contains the part of recipe corresponding to the instructions for the correct dose of the coffee powder, whereas the memory of the control unit of the coffee machine contains the part of recipe corresponding to the instructions for correctly brewing the drink starting from said coffee powder dose.

Therefore, in the described arrangement, the coffee grinder and the coffee machine execute each their own part of recipe without any control or check over the remaining part of the recipe. In other words, if for some reason the coffee grinder dispenses a dose of coffee powder that does not have the correct characteristics, the coffee machine will still execute its part of the recipe, thus obtaining as a final result a drink that does not correspond to the desired one.

The object of the present invention is to provide an arrangement that comprises a coffee machine and a coffee grinder and is alternative to the arrangements described above and capable to overcome the limitations thereof.

This and other objects are achieved by the arrangement as claimed in the appended claims.

### SUMMARY OF INVENTION

The invention relates to an arrangement comprising at least one coffee machine and at least one coffee grinder, wherein:
the coffee machine comprises a plurality of brewing groups, each brewing group having a plurality of buttons corresponding to the different coffee-based drinks that can be selected and prepared by the coffee machine;
the coffee machine further comprises a corresponding plurality of filter holder assemblies, each comprising a filter holder and a respective filter;
the coffee machine further comprises an electronics equipped with communication devices;
at least one filter holder assembly—preferably each filter holder assembly—comprises an electronics equipped with a memory in which the parameters of the different recipes of coffee-based drinks are stored, as well as with communication devices able to communicate with the communication devices of the electronics of the coffee machine;
the coffee grinder comprises a grinding chamber for grinding the coffee beans and obtaining coffee powder to be dispensed to a filter holder assembly;
the coffee grinder further comprises an electronics equipped with communication devices, wherein the communication devices of said at least one filter holder assembly—preferably of each filter holder assembly—are able to communicate with the communication devices of the electronics of the coffee grinder.

In the arrangement according to the invention, it is thus the filter holder assembly that contains the data concerning the different recipes and each time it is inserted into a device adapted for communication (in particular the coffee machine or the coffee grinder), it communicates the data necessary for the preparation of the selected recipe to this device.

The electronics can be provided in any part of the filter holder assembly; for example, it may be provided in the filter holder, but it may also be provided in the filter carried by said filter holder, or in another accessory associated with the filter holder.

In particular, initially, with the filter holder assembly connected to the coffee machine, it receives the consumer's selection from said coffee machine or another dedicated tool (e.g. a mobile device such as a tablet, a smartphone, etc.).

When subsequently the filter holder assembly is connected to the coffee grinder, it communicates to said coffee grinder the characteristics that the coffee powder necessary for the preparation of the selected recipe must have, in particular in terms of weight, particle size, pressing and the like.

When subsequently the filter holder assembly is connected again to the coffee machine, the filter holder assembly communicates the data necessary for brewing the desired drink, in particular in terms of quantity, pressure, flow rate and temperature of the water used for brewing.

Advantageously, thanks to the fact that the filter holder assembly has its own electronics, the filter holder assembly can communicate with devices other than the coffee machine and the coffee grinder, such as, for example, an automatic weighing device, an automatic presser, an external management and control unit, which may present in the arrangement.

To this aim, each of said devices (automatic weighing device, automatic presser, etc.) comprises an electronics equipped with communication devices, and the communication devices of the filter holder assembly are able to communicate with the communication devices of the electronics of such devices in order to communicate to said devices which operations they have to carry out to match the selected recipe.

In a preferred embodiment of the invention, at each brewing, the electronics of the filter holder assembly checks whether the parameters of the recipe stored therein are met, and, if they are not met, uses the error data to communicate to the coffee machine and/or to the coffee grinder the corrective actions to be taken for a subsequent brewing.

Advantageously, in the arrangement according to the invention, the filter holder assembly is not restrained to a specific brewing group, but it can be used in any brewing group of the coffee machine, because it can communicate each time to the coffee machine the settings required for the correct preparation of the selected coffee-based drink, regardless of the brewing group in which it is inserted. Another advantage of the invention, in comparison with the known arrangement described above, is that a filter holder assembly communicates with a device (coffee machine, coffee grinder . . . ) solely when it is inserted therein. This eliminates remote communications and the associated need for channel encoding to avoid interference between different and simultaneous communications.

The present invention finds particular application in arrangements comprising a coffee grinder and an espresso coffee machine, in particular an espresso coffee machine of the so-called “semi-automatic” type.

In this connection, it is to be noted that, whereas the arrangement described in US 2003/0129286 comprises a funnel of considerable size having a memory unit including a limited amount of basic information, the invention provides that a filter holder assembly of reduced size contains the whole data relating to the different recipes of the drinks that can be prepared by the arrangement.

### BRIEF DESCRIPTION OF DRAWINGS

Further features and advantages of the invention will become apparent from the following detailed description of some preferred embodiments of the invention, which are given by way of non-limiting example with reference to the annexed drawings, in which:

FIG. 1 shows an espresso coffee machine of the arrangement according to the invention.

FIG. 2 schematically shows a coffee grinder according to the invention.

FIG. 3 schematically shows the overall architecture of the arrangement according to the invention.

### DESCRIPTION OF EMBODIMENTS

The invention relates to an arrangement comprising at least one coffee machine and at least one coffee grinder.

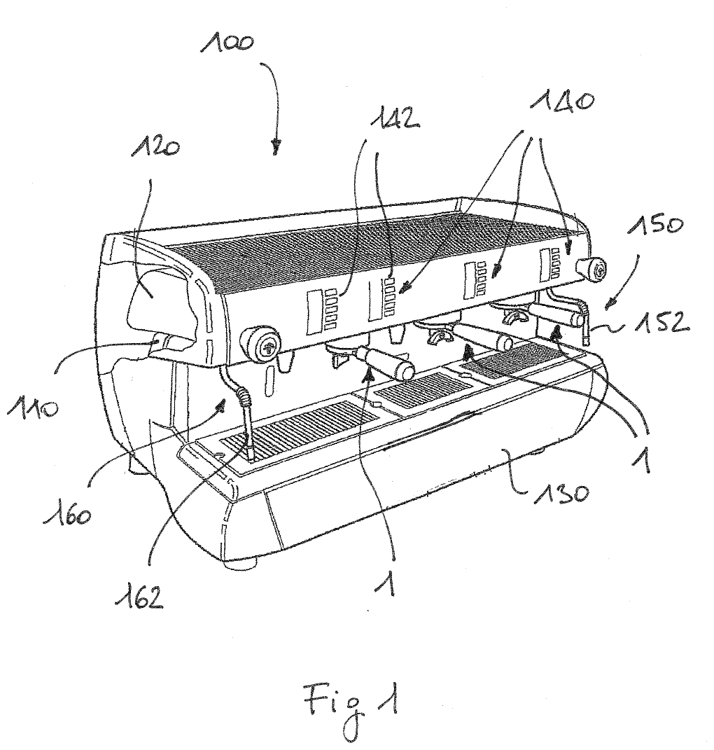

Referring at first to FIG. 1, there is shown schematically a coffee machine 100 of the arrangement according to the invention.

In a manner known per se, said coffee machine 100 comprises a frame 110, a boiler 120 intended for generating hot water and mounted to said frame, and a body 130 fixed to said frame and adapted to receive the boiler and to give the coffee machine a certain overall shape.

The coffee machine further comprises one or more brewing groups 140, each being in fluid communication with the boiler 120 and being provided with a series of buttons 142 by means of which the operator can select a particular coffee-based drink that has been ordered by a consumer.

The coffee machine further comprises corresponding filter holder assemblies 1, each of which includes at least one filter holder 1′ and one filter 1″ held by said filter holder and arranged to contain the desired dose of coffee powder.

The filter holder assemblies 1 may further include additional accessories, such as, for example, a blind filter for periodically carrying out a cleaning cycle of the coffee machine.

When an order for brewing a coffee is imparted, hot water coming from the boiler 120 is passed through the coffee powder contained in the filter 1″ held by the filter holder 1′ and the coffee thus obtained is collected in an underlying cup.

Generally, the coffee machine 100 may also comprise a hot water delivery station 150 equipped with a delivery tube 152 in fluid communication with the boiler 120, which can be used, for example, for preparing teas and infusions, as well as a station intended for whipping and frothing milk 160 for the preparation of hot frothed milk and comprising a steam wand 162 for introducing steam, possibly mixed with pressurized air, into the milk.

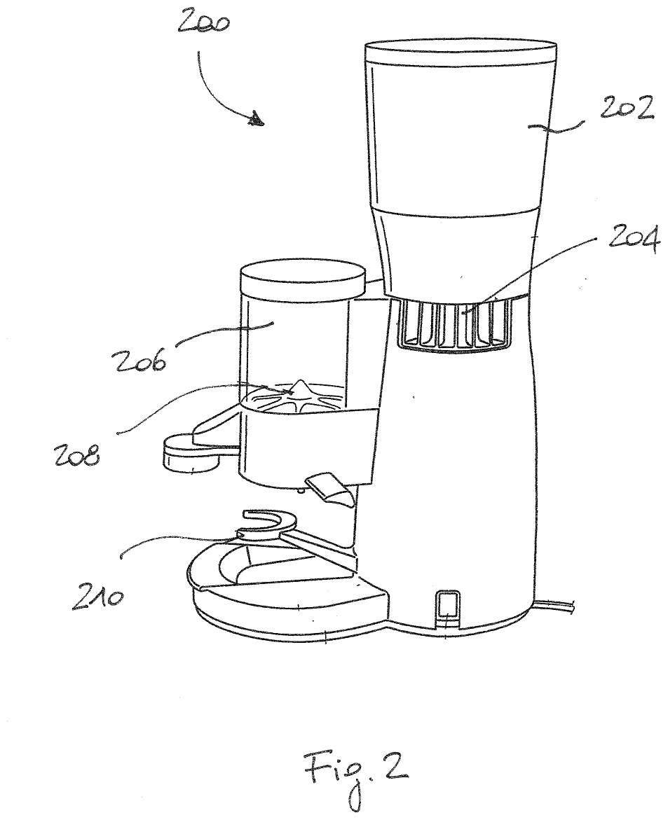

In order to obtain a drink with satisfactory organoleptic characteristics, the coffee used is preferably ground immediately before use and for this reason at least one coffee grinder 200, schematically shown in FIG. 2, is associated with the at least one coffee machine 100 of the arrangement according to the invention.

Said coffee grinder 200 includes a hopper 202 for the coffee beans, which are transferred by gravity to a grinding chamber 204.

In a manner known per se, inside the grinding chamber 204 there is/are provided one or more grinder blades that can be powered by a motor (for example, an electrical motor) and mutually cooperate to grind the coffee beans coming from the hopper 202 and turn them into coffee powder. Said grinder blades are preferably two in number, with or without motorized movement, and can be, for example, flat grinder blades or conical grinder blades.

From the grinding chamber 204, the coffee powder is transferred, again by gravity, to a second hopper 206, provided with dosing means 208 enabling proper dispensing of the amount of coffee required for preparing the desired drink into the filter 1″ of a filter holder 1′ of the coffee machine 100. To this aim, said filter holder 1′ can be accommodated on a support 210 arranged under the second hopper 206.

As anticipated above, generally the coffee machine 100 must be able to prepare different types of coffee-based drinks, i.e. to execute different “recipes”.

Each recipe will be distinguished by the type of coffee used, the quantity of coffee powder used and its particle size, the pressure, temperature and flow rate of the water used, and so on.

Since espresso coffee machines of the type shown in FIG. 1 are mainly used in commercial establishments, such as bars and restaurants, it is usual that several coffee-based drinks—possibly of different types—are ordered at the same time and that several operators operate simultaneously on the same coffee machine.

It is therefore necessary to implement an architecture for an arrangement comprising at least one coffee machine 100 and at least one coffee grinder 200 that allows avoiding errors and guarantees that a brewing group of the coffee machine 100 actually brews the drink corresponding to the operator's selection.

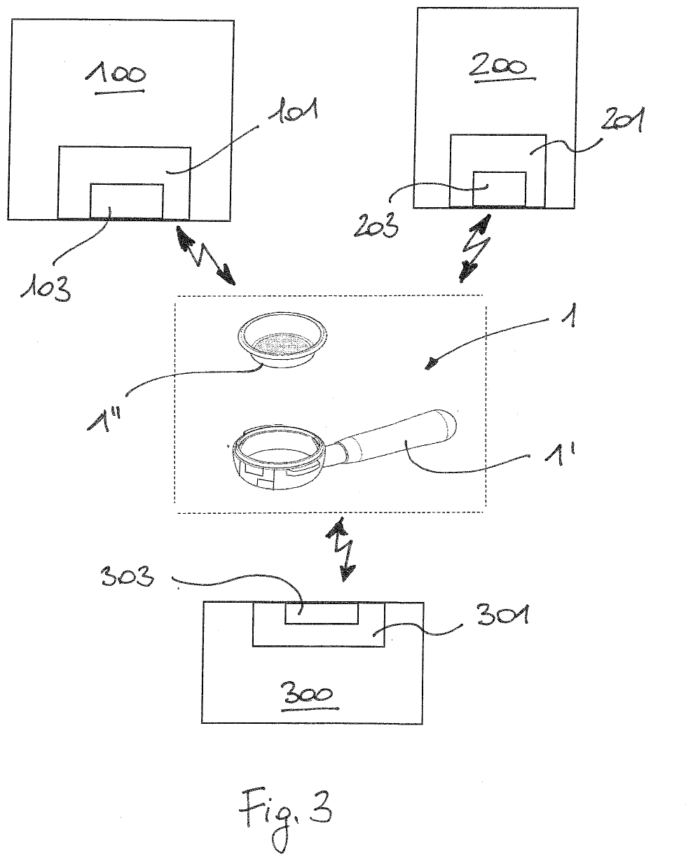

For this purpose, the arrangement according to the invention adopts the architecture schematically shown in FIG. 3.

According to the invention:
the coffee machine 100 comprises an electronics 101 equipped with communication devices 103;
the coffee grinder 200 comprises in turn an electronics 201 equipped with communication devices 203; and
at least one filter holder assembly 1—and preferably each filter holder assembly 1—comprises an electronics 11 equipped with a memory 15, in which there are stored the parameters of the different recipes of coffee-base drinks that can be executed by the coffee machine, and with communication devices 13 that are able to communicate with the communication devices 103 of the electronics 101 of the coffee machine 100 and are also able to communicate with the communication devices 203 of the electronics 201 of the coffee grinder 200.

In the arrangement according to the invention, it is therefore each filter holder assembly 1 that contains the data concerning the different recipes that can be prepared by the arrangement, for both the part concerning the operations to be carried out by the coffee grinder 200 and the part concerning the operations to be carried out by the coffee machine 100.

The electronics can be provided either in the filter holder 1′ or in the filter 1″. It may possibly be provided in a further accessory of the filter holder assembly 1.

In FIG. 3, the electronics is provided at the front part of the filter holder 1′; this configuration is advantageous when the front part of the filter holder is the portion of the filter holder that is closest to the device (coffee machine, coffee grinder and so on) with which the filter holder must communicate.

However, this location of the electronics 11 must not be understood in a limiting sense, and the electronics might be located in any other part of the filter holder 1′, for example in the handle.

In addition, as anticipated above, the electronics 11 may also be provided in the filter 1″ of the filter holder assembly 1.

Whenever a filter holder assembly 1 is inserted into an device adapted to communication (in particular, the coffee machine 100 or the coffee grinder 200), the filter holder assembly communicates to said device the data necessary for preparing the selected recipe.

Advantageously, thanks to the fact that the filter holder assembly has its own electronics, the filter holder assembly 1 can communicate with devices other than the coffee machine and the coffee grinder, such as, for example, an external management and control unit 300, which will in turn be provided with an electronics 301 equipped with communication devices 303 able to communicate with the communication devices 13 of the electronics of the filter holder assembly 1.

For example, a filter holder assembly 1 will be able to receive, from the external management and control unit 300, the parameters of new recipes for coffee-based drinks and/or may transmit, to said external management and control unit 300, historical and statistical data on the preparation of the different recipes.

The operation of the arrangement according to the invention can be summarized as follows.

At first, the filter holder assembly 1 is connected to the coffee machine 100, in particular it is inserted into any of the brewing groups of the coffee machine 100.

The electronics of each filter holder assembly will contain, in its memory, the recipe of one or more coffee-based drinks that can be prepared by the coffee machine 100.

The consumer makes his/her order and the operator selects the corresponding drink.

This selection can be effected starting from the coffee machine 100 or also from an external device, including a mobile device such as a smartphone or a tablet.

When the filter holder assembly 1 is connected to the coffee grinder 200 and inserted on the support 210 of said coffee grinder, the electronics 11 of the filter holder assembly communicates with the electronics 201 of the coffee grinder.

According to a first possible embodiment, the coffee grinder enables only those selection buttons that correspond to one of the recipes stored in the memory 15 of the filter holder assembly 1. The operator will then effect the selection, among the enabled buttons, of the option corresponding to the desired drink.

According to a second, more sophisticated embodiment of the invention, the electronics 11 of the filter holder assembly 1 communicates directly to the electronics of the coffee grinder the characteristics that the coffee powder necessary for the preparation of the selected recipe must have, in particular in terms of weight, particle size, pressing and the like.

In both cases, the settings of the grinding chamber (grinding time, distance between the grinder blades, etc.) will be modified accordingly based on the instructions received from the operator or directly from the filter holder assembly.

Once the filter holder assembly 1 has been filled with the dose of coffee powder, it is again connected to the coffee machine 100.

In this connection, it should be noted that the filter holder assembly could be inserted into any brewing group 140 of the coffee machine 100, possibly also in a brewing group different from the initial one.

At this stage, the electronics 11 of the filter holder communicates with the electronics of the coffee machine.

In this case, too, in a first embodiment of the invention, only the buttons 142 of the brewing group 140 that were present in the memory 15 of the filter holder assembly 1 and correspond to one of the recipes stored therein are enabled for the operator. The operator will then proceed to the selection, among the enabled buttons, of the option corresponding to the desired drink.

According to a second, more sophisticated embodiment of the invention, the electronics of the filter holder assembly communicates directly to the electronics of the coffee machine the data necessary for brewing the desired drink, in particular in terms of pressure, flow rate and temperature of the water used for brewing.

In both cases, the settings of the coffee machine (in particular those of the boiler and those of the brewing group) will be modified accordingly based on the instructions received from the operator or directly from the filter holder assembly.

The drink thus brewed can be collected in an underlying mug or cup and served to the consumer.

It will be evident to the person skilled in the art that the invention advantageously provides that the recipe for the drink to be prepared is stored in the component (the filter holder assembly) that moves within the arrangement during the various preparation steps and is involved in all said preparation steps, and it is this component that acts as “master” for the other devices and devices (coffee machine, coffee grinder, . . . ) of the arrangement, which act as “slave” and just carry out the indicated actions.

In a preferred embodiment of the invention, at each brewing, the electronics 11 of the filter holder assembly 1 checks whether the reference values of each parameter involved in the recipe (dose of coffee powder, particle size of the coffee powder, water temperature and pressure, etc.) stored in its memory 15 are met by the coffee machine 100 and by the coffee grinder 200.

In the event that the difference between an actual value recorded and the corresponding reference value is greater than a predetermined threshold, the filter holder assembly 1 will be able to communicate with the device concerned, in order to impart instructions about the corrective actions to be taken for a subsequent brewing.

For example, if the actual particle size of the coffee powder were different from the reference value stored in the filter holder and required by the recipe, the filter holder assembly 1 would communicate with the coffee grinder 200 to instruct a change in the relative distance of the grinder blades in the grinding chamber 204 of the coffee grinder.

It will be evident to the person skilled in the art that the invention is not limited to the embodiment described in detail above and that numerous modifications and variations are possible without departing from the scope of protection defined in the accompanying claims.

In particular, although only one coffee machine and only one coffee grinder are illustrated in the Figures, it is also possible to envisage that the arrangement comprises a plurality of coffee machines and/or a plurality of coffee grinders.

Furthermore, in addition to the management and control unit shown in FIG. 3, the arrangement may comprise other apparatuses able to communicate with the filter holder assembly, among which there can be mentioned, by way of non-exclusive example, one or more weighing devices, one or more pressers, one or more mobile devices such as smartphones and tablets.

1. An arrangement comprising at least one espresso coffee machine and at least one coffee grinder, wherein the at least one espresso coffee machine comprises a plurality of brewing groups and also comprises a corresponding plurality of filter holder assemblies, each comprising at least one filter holder and a respective filter, carried by the filter holder and adapted to contain the desired dose of coffee powder, wherein the at least one coffee grinder comprises a grinding chamber for grinding coffee beans and obtaining coffee powder to be dispensed to one of the filter holder assemblies, wherein the at least one espresso coffee machine is configured to prepare a plurality of different coffee-based drinks according to different recipes, wherein the at least one espresso coffee machine further comprises an electronics equipped with communication devices wherein the at least one coffee grinder further comprises an electronics equipped with communication devices, wherein one or more of the filter holder assemblies comprise an electronics equipped with a memory, in which the parameters of one or more of the recipes are stored, and with communication devices, the communication devices of the electronics of the filter holder assembly being able to communicate with the communication devices of the electronics of the espresso coffee machine in order to communicate to the espresso coffee machine the data necessary for preparing a selected recipe, and also being able to communicate with the communication devices of the electronics of the coffee grinder in order to communicate to the coffee grinder the data necessary for preparing the selected recipe.

2. The arrangement according to claim 1, wherein all the filter holder assemblies comprise an electronics provided with a memory, in which the parameters of the recipes are stored, and with communication devices, the communication devices of the electronics of the filter holder assemblies being able to communicate with the communication devices of the electronics of the espresso coffee machine in order to communicate to the espresso coffee machine the data necessary for preparing a selected recipe, and also being able to communicate with the communication devices of the electronics of the coffee grinder in order to communicate to the coffee grinder the data necessary for preparing the selected recipe.

3. The arrangement according to claim 1, wherein the electronics of the filter holder assembly is located in a front portion of the filter holder of the filter holder assembly.

4. The arrangement according to claim 1, wherein the electronics of the filter holder assembly is located in a filter of the filter holder assembly.

5. The arrangement according to claim 1, further comprising an external management and control unit, wherein the external management and control unit is provided with an electronics equipped with communication devices, and wherein the communication devices of the electronics of the filter holder assembly are able to communicate with the communication devices of the electronics of the external management and control unit.

6-7. (canceled)

8. The arrangement according to claim 1, wherein for each parameter of each recipe stored in the memory of the electronics of the filter holder assembly a reference value is stored in the memory of the electronics of the filter holder assembly, wherein one or more of the parameters of the recipes are measured during brewing, and wherein, at each brewing cycle, the filter holder assembly is able to compare the reference values of one or more of the parameters of the recipe with the actual values of the corresponding parameters measured during brewing.

9. The arrangement according to claim 8, in which the filter holder assembly is arranged to impart instructions to the espresso coffee machine and/or to the coffee grinder for carrying out corrective actions in the event that the difference between one or more of the actual values of the parameters of the recipe and the respective reference values is greater than a predetermined threshold.

10. A method for the operation of the arrangement according to claim 1, comprising the following steps:
a coffee-based drink is selected from a plurality of coffee-based drinks that can be prepared by the espresso coffee machine;
the selection made is communicated to the filter holder assembly inserted in a brewing group of the espresso coffee machine, the filter holder assembly having stored in its memory all the parameters relating to the recipe of the selected drink;
the filter holder assembly is connected to the coffee grinder and communicates to the coffee grinder the characteristics required for the coffee powder necessary for the preparation of the selected recipe or of all the recipes stored in said memory;
the settings of the grinding chamber of the coffee grinder are correspondingly modified and the coffee powder with the required characteristics is produced and dispensed to the filter holder assembly;
the filter holder assembly is transferred to the espresso coffee machine and inserted into a brewing group of the espresso coffee machine;
the filter holder assembly communicates to the espresso coffee machine the data necessary for the preparation of the selected recipe;
the settings of the brewing group of the espresso coffee machine are correspondingly modified and the coffee-based drink with the required characteristics is brewed.

11. The method according to claim 10, wherein for each parameter of each recipe stored in the memory of the electronics of the filter holder assembly a reference value is stored in the memory of the electronics of the filter holder assembly, wherein one or more of the parameters of the recipes are measured during brewing, and wherein, at each brewing cycle, the filter holder assembly compares the reference values of one or more of the parameters of the recipe with the actual values of the corresponding parameters measured during brewing.

12. The method according to claim 11, in which the filter holder assembly imparts instructions to the espresso coffee machine and/or to the coffee grinder for carrying out corrective actions in the event that the difference between one or more of the actual values of the parameters of the recipe and the respective reference values is greater than a predetermined threshold.

13. A method for the operation of the arrangement of claim 1, comprising the following steps:
a coffee-based drink is selected from a plurality of coffee-based drinks that can be prepared by the espresso coffee machine;
the selection made is communicated to the filter holder assembly inserted in a brewing group of the espresso coffee machine, the filter holder assembly having stored in its memory all the parameters relating to the recipe of the selected drink;
the filter holder assembly is connected to the coffee grinder and communicates to the coffee grinder the characteristics required for the coffee powder necessary for the preparation of all the recipes stored in its memory;
among the recipes stored in the memory of the filter holder assembly, the recipe corresponding to the selected drink is selected;
the settings of the grinding chamber of the coffee grinder are correspondingly modified and the coffee powder with the required characteristics is produced and dispensed to the filter holder assembly;
the filter holder assembly is transferred to the espresso coffee machine and inserted into a brewing group of the espresso coffee machine;
the filter holder assembly communicates to the espresso coffee machine the data necessary for the preparation of all the recipes stored in its memory;
among the recipes stored in the memory of the filter holder assembly, the recipe corresponding to the selected drink is selected;
the settings of the brewing group of the espresso coffee machine are correspondingly modified and the coffee-based drink with the required characteristics is brewed.

14. The method according to claim 13, wherein for each parameter of each recipe stored in the memory of the electronics of the filter holder assembly a reference value is stored in the memory of the electronics of the filter holder assembly, wherein one or more of the parameters of the recipes are measured during brewing, and wherein, at each brewing cycle, the filter holder assembly compares the reference values of one or more of the parameters of the recipe with the actual values of the corresponding parameters measured during brewing.

15. The method according to claim 14, in which the filter holder assembly imparts instructions to the espresso coffee machine and/or to the coffee grinder for carrying out corrective actions in the event that the difference between one or more of the actual values of the parameters of the recipe and the respective reference values is greater than a predetermined threshold.
